(19) United States
(12) Patent Application Publication
(10) Pub. No.: US 2023/0027389 A1
(43) Pub. Date: Jan. 26, 2023

(54) DISTANCE DETERMINATION METHOD, APPARATUS AND SYSTEM

(71) Applicant: MEGVII (BEIJING) TECHNOLOGY CO., LTD., Beijing (CN)

(72) Inventor: Gang HU, Beijing (CN)

(21) Appl. No.: 17/758,370

(22) PCT Filed: Sep. 30, 2020
(86) PCT No.: PCT/CN2020/119625

§ 371 Date: Jul. 5, 2022

(30) Foreign Application Priority Data
Apr. 1, 2020 (CN) 202010252906.8

(51) Int. Cl. G06V 10/74; G06V 10/24; G06V 10/44; G06V 10/98; G06T 7/593; G01M 11/02

(52) U.S. Cl. CPC G06V 10/761; G06V 10/242; G06V 10/44; G06V 10/98; G06T 7/593; G01M 11/0221

(57) ABSTRACT

The present disclosure provides a distance determination method, apparatus and system, relating to the technical field of image processing. The method includes the following steps: acquiring a master visual image photographed by a master camera and an original auxiliary visual image photographed by an auxiliary camera; acquiring an initial matching point pair between the master visual image and the original auxiliary visual image through feature extraction and feature matching; correcting the original auxiliary visual image sequentially, based on the initial matching point pair and different constraints, so as to obtain a target auxiliary visual image, wherein the different constraints includes: a constraint of a minimum rotation angle and a constraint of a minimum parallax; and determining a focusing distance according to the master visual image and the target auxiliary visual image. The focusing distance can be determined more accurately.

### CROSS REFERENCE TO RELATED APPLICATIONS

The application claims priority to Chinese Patent Application No. 202010252906.8, entitled “Distance Determination Method, Apparatus and System”, which was filed on Apr. 1, 2020, in the Chinese Patent Office, the entire contents of which are incorporated in the present application by reference.

### TECHNICAL FIELD

The present disclosure relates to the technical field of image processing, in particular, to a distance determination method, apparatus and system.

### BACKGROUND

Multi-camera refers to a combination design including a master camera and at least one auxiliary camera, and is mostly used in a photographing apparatus such as a mobile phone to simulate imaging effect of a single-lens reflex lens. For the sake of portability, the existing multi-camera photographing apparatuses are small in size. Due to this limitation, the base distance and the focal length of the multi-camera are not large enough, which makes it necessary to take a picture within a certain effective distance to achieve a good result. Based on this, the photographing apparatus usually needs to detect the focusing distance to prompt the user whether the current photographing exceeds a limited effective distance.

The above-mentioned photographing apparatus may use a common dual-camera ranging technology to measure the distance. In this ranging mode, the binocular image is corrected using the calibration data set at the factory, and then the focusing distance is determined based on the corrected image. However, with the problems (such as falling and aging) of the photographing apparatus during use, structural parameters between the two cameras have changed, which makes the calibration data no longer accurate. Moreover, the camera itself is zoomed, which also has a certain impact on ranging, thereby reducing the accuracy of ranging.

### SUMMARY

In view of this, the present disclosure aims to provide a distance determination method, apparatus and system, which can determine the focusing distance more accurately.

To achieve the above objectives, the technical solution of the embodiments of the present disclosure is realized as follows:

In a first aspect, an embodiment of the present disclosure provides a distance determination method. The method includes the following steps: acquiring a master visual image photographed by a master camera and an original auxiliary visual image photographed by an auxiliary camera; acquiring an initial matching point pair between the master visual image and the original auxiliary visual image through feature extraction and feature matching; correcting the original auxiliary visual image sequentially, based on the initial matching point pair and different constraints, so as to obtain a target auxiliary visual image, wherein the different constraints includes: a constraint of a minimum rotation angle and a constraint of a minimum parallax; and determining a focusing distance according to the master visual image and the target auxiliary visual image.

In one alternative implementation, the step of acquiring the initial matching point pair between the master visual image and the original auxiliary visual image through feature extraction and feature matching, includes: extracting an initial primary feature point in the master visual image and an initial auxiliary feature point in the original auxiliary visual image; calculating a similarity between any feature point pair, wherein the feature point pair includes one initial primary feature point and one initial auxiliary feature point; determining a candidate matching point pair according to the similarity; and screening the candidate matching point according to a sampling consistency algorithm, so as to obtain an initial matching point pair, wherein the initial matching point pair includes the initial primary feature point and the initial auxiliary feature point which have a matching relationship.

In one alternative implementation, the step of correcting the original auxiliary visual image sequentially, based on the initial matching point pair and preset constraints, so as to obtain the target auxiliary visual image, includes: correcting the initial auxiliary feature point in the initial matching point pair according to a preset stereo correction model, so as to obtain a target auxiliary feature point, wherein the stereo correction model represents a conversion relationship from a coordinate system of the auxiliary camera to a coordinate system of the master camera; correcting the original auxiliary visual image based on the constraint of the minimum rotation angle, and based on the initial primary feature point and the target auxiliary feature point which have a matching relationship in the initial matching point pair, so as to obtain a first auxiliary visual image; and correcting the first auxiliary visual image based on the constraint of the minimum parallax, and based on the initial primary feature point and the target auxiliary feature point which have the matching relationship, so as to obtain a target auxiliary visual image.

In one alternative implementation, the step of correcting the original auxiliary visual image based on the constraint of the minimum rotation angle, and based on the initial primary feature point and the target auxiliary feature point which have the matching relationship in the initial matching point pair, so as to obtain the first auxiliary visual image, includes: acquiring coordinate values of the initial primary feature point and the target auxiliary feature point on a first coordinate axis, respectively, based on the coordinate system of the master camera, wherein the coordinate system of the master camera is a spatial three-dimensional coordinate system established by taking an optical center of the master camera as an origin, taking a direction in which the optical center of the master camera points to an optical center of the auxiliary camera as a second coordinate axis, and taking an optical axis direction of the master camera as a third coordinate axis, and the first coordinate axis is a coordinate axis perpendicular to the second coordinate axis and the third coordinate axis; optimizing a correction cost of a rotation angle according to the acquired coordinate values and Levinberg-Marquardt (LM) algorithm, so as to obtain the minimum rotation angle, wherein the rotation angle is generated in a process of rotating the original auxiliary visual image to be aligned with the master visual image; and correcting the original auxiliary visual image according to the minimum rotation angle, so as to obtain the first auxiliary visual image.

In one alternative implementation, the correction cost of the rotation angle meets an expression as follows:

$$\begin{matrix}costFunction ( R ) = costFunction ( Rx , Ry , Rz ) \\ = {\sum }_{i = 1}^{n} \{ {P}_{i - y}^{L} - {[ ( {K}_{L} ⋆ {R}^{- 1} ⋆ {K}_{R}^{- 1} ) ⋆ {P}_{i}^{R} ]}_{y} \} \\ = {\sum }_{i = 1}^{n} \{ {P}_{i - y}^{L} - {P}_{i - y}^{R} \}\end{matrix}$$

wherein costFunction(R) represents the correction cost of the rotation angle, R represents the rotation angle, Rx represents a pitch angle rotated around the second coordinate axis, Ry represents a yaw angle rotated around the first coordinate axis, Rz represents a roll angle rotated around the third coordinate axis, P^{L}_{i-y} represents a coordinate value of the i-th initial primary feature point in the master visual image on the first coordinate axis, and P^{R}_{i-y} represents a coordinate value of the i-th target auxiliary feature point in the auxiliary visual image on the first coordinate axis.

In one alternative implementation, the step of determining the focusing distance according to the master visual image and the target auxiliary visual image, includes:
calculating a parallax image of the master visual image and the target auxiliary visual image;
converting the parallax image into a depth image according to a conversion relationship between parallax and depth;
determining the focusing distance according to the depth image.

In one alternative implementation, a construction process of the stereo correction model includes: determining the coordinate system of the master camera as a reference coordinate system; constructing the stereo correction model in the reference coordinate system according to a preset calibration parameter of a binocular camera, wherein the binocular camera includes the master camera and the auxiliary camera.

In one alternative implementation, the stereo correction model meets expressions as follows:

H_{L}=K_{L}*K_{L}⁻¹

H_{R}=K_{L}*R⁻¹*K_{R}⁻¹

wherein H_{L} represents a conversion relationship from the coordinate system of the master camera to the reference coordinate system, K_{L} represents a preset internal parameter matrix of the master camera, H_{R} represents a conversion relationship from the coordinate system of the auxiliary camera to the reference coordinate system, K_{R} represents a preset internal parameter matrix of the auxiliary camera, and R represents a rotation matrix from the coordinate system of the auxiliary camera to the coordinate system of the master camera.

In one alternative implementation, the step of correcting the first auxiliary visual image based on the constraint of the minimum parallax, and based on the initial primary feature point and the target auxiliary feature point which have the matching relationship, so as to obtain the target auxiliary visual image, includes: acquiring the coordinate values of the initial primary feature point and the target auxiliary feature point on the second coordinate axis , respectively, based on the coordinate system of the master camera; determining a feature point parallax between the initial primary feature point and the target auxiliary feature point which have the matching relationship according to the acquired coordinate values; selecting a plurality of initial matching point pairs with a minimum feature point parallax, and taking the selected plurality of the initial matching point pairs as target matching point pairs, wherein the target matching point pair includes the initial primary feature point and the target auxiliary feature point which have the matching relationship; optimizing the correction cost of a yaw angle according to the feature point parallax of the target matching point pair and LM algorithm, so as to obtain a minimum yaw angle, wherein the yaw angle is generated in a process of rotating the original auxiliary visual image along the first coordinate axis to be aligned with the master visual image; and correcting the first auxiliary visual image according to the minimum yaw angle, so as to obtain the target auxiliary visual image.

In one alternative implementation, the constraint of the minimum rotation angle includes:
determining the minimum rotation angle to rotate the original auxiliary visual image to align with the master visual image, according to the coordinate values of the feature points in the plurality of the matching point pairs, wherein the rotation angle is Euler angle.

In one alternative implementation, the constraint of the minimum parallax includes:
determining the minimum yaw angle to rotate the original auxiliary visual image to align with the master visual image by using the coordinate values of the feature points in the plurality of the matching point pairs with the minimum parallax.

In a second aspect, an embodiment of the present disclosure provides a distance determination apparatus. The apparatus includes: an image acquisition module configured to acquire a master visual image photographed by a master camera and an original auxiliary visual image photographed by an auxiliary camera; a feature matching module configured to acquire an initial matching point pair between the master visual image and the original auxiliary visual image through feature extraction and feature matching; an image correction module configured to correct the original auxiliary visual image, sequentially, based on the initial matching point pair and different constraints, so as to obtain a target auxiliary visual image, wherein the different constraints includes: a constraint of a minimum rotation angle and a constraint of a minimum parallax; and a distance determination module configured to determine a focusing distance according to the master visual image and the target auxiliary visual image.

In a third aspect, an embodiment of the present disclosure provides a distance determination system. The system includes a processor and a storage device. A computer program is stored on the storage device, and when the computer program is executed by the processor, the distance determination method according to any one of the first aspect is implemented.

In a fourth aspect, an embodiment of the present disclosure provides a computer-readable storage medium. A computer program is stored on the computer-readable storage medium, and when the computer program is executed by a processor, the distance determination method according to any one of the first aspect is implemented.

The embodiment of the present disclosure provides a distance determination method, apparatus and system. First, acquiring an initial matching point pair between a master visual image and an original auxiliary visual image; second, correcting the original auxiliary visual image based on the initial matching point pair and based on the constraint of the minimum rotation angle and the constraint of the minimum parallax, so as to obtain the target auxiliary visual image; then, determining a focusing distance of the binocular camera according to the master visual image and the target auxiliary visual image. In the above mode provided by the embodiment of the present disclosure, first, limited by the constraint of the minimum rotation angle, the accuracy of alignment between the rotation angle of the corrected auxiliary visual image and the master visual image is improved; then, considering that when the feature point parallax approaches 0, which means that the point is at infinity, the matching point pair with the minimum parallax may be used (that is, limited by the constraint of the minimum parallax) to improve the alignment accuracy of the auxiliary visual image with the master visual image in the vertical direction after re-correction. Based on the above-mentioned correction process, the accuracy of the image correction result can be effectively improved, so that the focusing distance determined thereby can also have high accuracy.

Other features and advantages of the present disclosure will be set forth in the description that follows. Alternatively, some features and advantages may be inferred or unambiguously determined from the description, or may be learned by practice of the above techniques of the present disclosure.

In order to make the above objects, features and advantages of the present disclosure more understandable, the preferred embodiments are given below, and are described in detail as follows in conjunction with the accompanying drawings.

### BRIEF DESCRIPTION OF THE DRAWINGS

In order to more clearly illustrate the specific embodiments of the present disclosure or the technical solutions in the prior art, the following will briefly introduce the drawings required in the description of the specific embodiments or the prior art. Obviously, the drawings in the following description are some embodiments of the present disclosure, and for those of ordinary skill in the art, other drawings may also be obtained according to these drawings without any creative effort.

FIG. 1 illustrates a schematic structural diagram of an electronic device provided by an embodiment of the present disclosure;

FIG. 2 illustrates a flow chart of a distance determination method provided by an embodiment of the present disclosure;

FIG. 3 illustrates a schematic diagram of a binocular model provided by an embodiment of the present disclosure;

FIG. 4 illustrates a schematic diagram of a triangulation ranging model provided by an embodiment of the present disclosure;

FIG. 5 illustrates a structural block diagram of a distance determination apparatus provided by an embodiment of the present disclosure.

### DETAILED DESCRIPTION

In order to make the objects, technical solutions and advantages of the present disclosure more clear, the technical solutions of the embodiments of the present disclosure will be clearly and completely describe in conjunction with the accompanying drawings of the embodiments of the present disclosure. Obviously, described embodiments are part of the embodiments of the present disclosure, not all of the embodiments. Based on the described embodiments of the present disclosure, all of other embodiments acquired by those skilled in the art without the need for creative work are fall within the protection scope of the present disclosure.

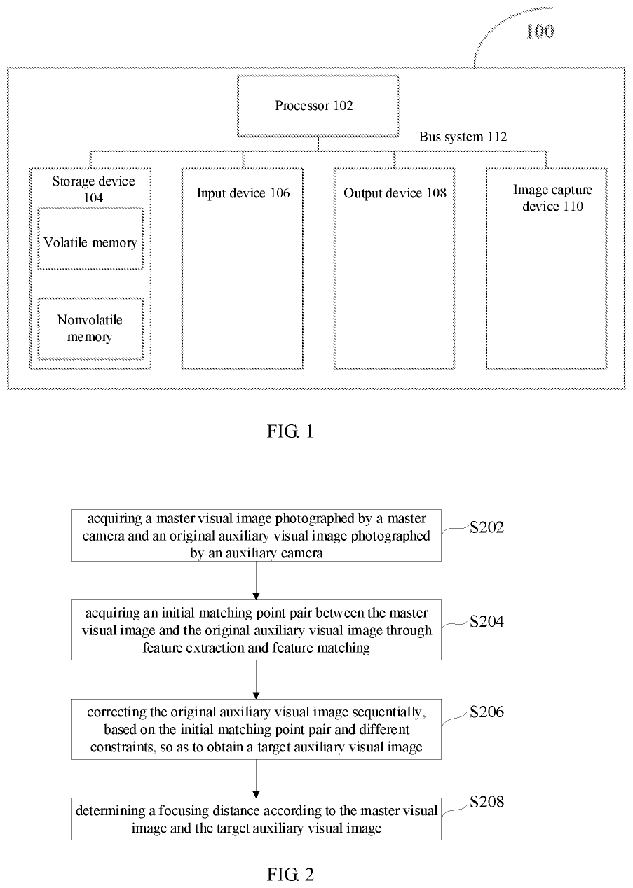

Considering the existing photographing apparatus with multi-camera, with the problems such as falling and aging during use, the calibration data set at the factory is no longer accurate, and then the calibration data can't be used to accurately correct the image. Thus, the distance detection is affected, and the accuracy of distance measurement is reduced. Based on this, in order to solve at least one of the above problems, the embodiment of the present disclosure provides a distance determination method, apparatus and system, which may be applied to a photographing apparatus (such as a mobile phone and a tablet computer, etc.) with multiple cameras, and realizes the functions of image correction and distance detection, and so on. For ease of understanding, the following describes the embodiments of the present disclosure in detail. First, referring to FIG. 1, an exemplary electronic device 100 for implementing the distance determination method, apparatus and system according to the embodiment of the present disclosure is depicted.

FIG. 1 illustrates a schematic structural diagram of an electronic device. The electronic device 100 includes one or more processors 102, one or more storage devices 104, an input device 106, an output device 108 and an image capture device 110. These components are interconnected via a bus system 112 and/or other forms of connection mechanisms (not shown). It should be noted that, the components and structures of the electronic device 100 shown in FIG. 1 are only exemplary, but not for limitation. According to requirements, the electronic device may have part of the components as shown in FIG. 1 or may have other components and structures not shown in FIG. 1.

The processor 102 may be a central processing unit (CPU) or other forms of processing unit with data processing capability and/or instruction execution capability, and may control other components in the electronic device 100 to perform a desired function.

The storage device 104 may include one or more computer program products. The computer program product may include various forms of computer readable storage media, such as volatile memory and/or nonvolatile memory. The volatile memory may include, for example, random access memory (RAM) and/or cache. The nonvolatile memory may include, for example, read only memory (ROM), hard disk, flash memory, etc. The computer-readable storage medium may store one or more computer program instructions, and the processor 102 may execute the program instruction to implement the client function (implemented by the processor) in the embodiments of the present disclosure described below and/or other desired functions. The computer-readable storage medium may further store various applications and various data, such as various data used and/or generated by the applications.

The input device 106 may be a device used by the user to input the instructions, and may include one or more of keyboards, a mouse, a microphone, a touch screen, and the like.

The output device 108 may output various kinds of information (e.g., images or sounds) to the outside (e.g., a user), and may include one or more of a display, a speaker, and the like.

The image capture device 110 can capture an image (such as a photo, a video, etc.) desired by the user, and store the captured image in the storage device 104 for use by other components.

For example, an exemplary electronic device for implementing the distance determination method, apparatus and system according to the embodiments of the present disclosure may be implemented on a smart terminal such as a smart phone and a tablet computer.

The embodiment of the present disclosure provides a distance determination method, and the method may be executed by the electronic device in the above embodiments. Referring to the flowchart of a distance determination method shown in FIG. 2, the method specifically includes the following steps:

S202: Acquiring a master visual image photographed by a master camera and an original auxiliary visual image photographed by an auxiliary camera.

When the photographing apparatus starts to measure the distance, the master camera and the auxiliary camera synchronously shoot a group of images including the master visual image and the original auxiliary visual image for a far-view scene. Wherein, in general, the far-view scene is a scene with the distance of greater than 10 meters. The above synchronization may refer to a shooting interval between the master camera and the auxiliary camera within a specified time (e.g., <10ms).

Usually, among the multiple cameras equipped on the photographing apparatus, the master camera is responsible for shooting and framing, and the at least one of other auxiliary camera is responsible for measuring the depth of field range, zooming, increasing the amount of light, color adjustment or detail adjustment, and other auxiliary imaging. When there are more than two auxiliary cameras equipped on the actually used photographing apparatus, the above-mentioned original auxiliary visual image may be any one of the auxiliary images photographed by a plurality of auxiliary cameras. For convenience of description, the master camera and the auxiliary camera used in the embodiment of the present disclosure may be referred to as a binocular camera.

S204: Acquiring an initial matching point pair between the master visual image and the original auxiliary visual image through feature extraction and feature matching.

First, feature points of the master visual image and the original auxiliary visual image are extracted, and then a plurality of initial matching point pairs are determined based on the matching degree between the feature points in the two images. The initial matching point pair includes a feature point of the master visual image and a feature point of the original auxiliary visual image which have the matching relationship. For example, in a scene containing a target human face, a feature point of a nose in the master visual image and a feature point of a nose in the original auxiliary visual image constitute an initial matching point pair.

S206: Correcting the original auxiliary visual image sequentially, based on the initial matching point pair and different constraints, so as to obtain a target auxiliary visual image.

The different constraints include: a constraint of a minimum rotation angle and a constraint of a minimum parallax. The constraint of the minimum rotation angle may be understood as follows: according to the coordinate values of the feature points in the plurality of initial matching point pairs, the minimum rotation angle to rotate the original auxiliary visual image to align with the master visual image is determined. The rotation angle is Euler angle, which includes a pitch angle rotated around X axis, a yaw angle rotated around Y axis and a roll angle rotated around Z axis. The constraint of the minimum parallax may be understood as follows: the minimum yaw angle to rotate the original auxiliary visual image to align with the master visual image is determined by using the coordinate values of the feature points in the plurality of initial matching point pairs with a minimum feature point parallax. It can be understood that, according to an optical triangulation method, when the feature point parallax approaches 0, the feature point is at infinity. Then, calculating the minimum yaw angle based on the matching point pair with the minimum parallax, a more accurate image correction result may be obtained, and the accuracy of the distance measured thereby may be improved.

In the embodiment of the present disclosure, the original auxiliary visual image is first corrected using the constraint of the minimum rotation angle, so as to obtain a first auxiliary visual image, and then the first auxiliary visual image is corrected again using the constraint of the minimum parallax, so as to obtain the target auxiliary visual image. Compared with the correction method of rotating the master visual image and the auxiliary visual image simultaneously in the prior art, the correction method provided by the embodiment of the present disclosure maintains the master visual image unchanged and rotates the original auxiliary visual image to align with the master visual image, which reduces the unknown parameters in the correction process and increases robustness. Further, limiting by the constraints, the accuracy of image correction result is improved.

S208: Determining a focusing distance according to the master visual image and the target auxiliary visual image.

After obtaining the master visual image and the target auxiliary visual image that have been stereo corrected, BM (Block Matching) algorithm or SGBM (Semi-Global Block matching) algorithm may be used to calculate a parallax image, and then the parallax image is converted into a depth image according to a conversion relationship between the parallax and the depth. The depth image records the distance between the subject captured in the scene and the camera, that is, the focusing distance is determined by the depth image.

The distance determination method provided by the embodiment of the present disclosure includes the following steps: first, acquiring an initial matching point pair between a master visual image and an original auxiliary visual image; second, correcting the original auxiliary visual image based on the initial matching point pair, and based on the constraint of the minimum rotation angle and the constraint of the minimum parallax, so as to obtain the target auxiliary visual image; then, determining a focusing distance of the binocular camera according to the master visual image and the target auxiliary visual image. In the above mode provided by the embodiment of the present disclosure, first, limited by the constraint of the minimum rotation angle, the accuracy of alignment between the rotation angle of the corrected auxiliary visual image and the master visual image is improved; then, considering that when the feature point parallax approaches 0, which means that the point is at infinity, the matching point pair with the minimum parallax may be used (that is, limited by the constraint of the minimum parallax) to improve the alignment accuracy of the auxiliary visual image with the master visual image in the vertical direction after re-correction. Based on the above-mentioned correction process, the accuracy of the image correction result can be effectively improved, so that the focusing distance determined thereby may also have higher accuracy.

For the above step S204, the embodiment of the present disclosure provides a method for acquiring the initial matching point pair between the master visual image and the original auxiliary visual image, referring to the following steps 1 to 4:

Step 1: Extracting an initial primary feature point in the master visual image and an initial auxiliary feature point in the original auxiliary visual image. In particular, such as SURF (Speeded Up Robust Features) algorithm may be used to extract the initial primary feature point in the master visual image and the initial auxiliary feature point in the original auxiliary visual image.

Step 2: Calculating a similarity between any feature point pair; wherein the feature point pair includes one initial primary feature point and one initial auxiliary feature point. Wherein, the similarity may be characterized by the distance (such as Euclidean distance, cosine similarity, etc.) between the initial primary feature point and the initial auxiliary feature point.

Step 3: Determining the candidate matching point pair according to the similarity, wherein the candidate matching point pair includes the initial primary feature point and the initial auxiliary feature point which have a matching relationship. The higher the similarity between the initial primary feature point and the initial auxiliary feature point, the greater the possibility that the two feature points correspond to the same point in space, so that the initial primary feature point and the initial auxiliary feature point which have the matching relationship may be determined based on the similarity.

Step 4: Screening the candidate matching point according to the RANSAC (RANdom Sample Consensus) algorithm, so as to obtain the initial matching point pair.

There may be data noise in the candidate matching point pairs, such as the matching point pair with wrong matching, the initial primary feature point has matching relationships with a plurality of initial auxiliary feature points, etc. In order to eliminate the data noise, in the embodiment of the present disclosure, the candidate matching points are screened according to the RANSAC algorithm, so as to screen out the initial matching point pair with higher matching accuracy, and the initial matching point pair includes the initial primary feature point and the initial auxiliary feature point having the matching relationship.

According to the initial matching point pair obtained by screening, the embodiment of the present disclosure provides an image correction method based on the initial matching point pair and different constraints, which mainly includes the following three steps:

Feature point correction step: correcting the initial auxiliary feature point according to a preset stereo correction model, so as to obtain a target auxiliary feature point. Wherein, the stereo correction model represents a conversion relationship from a coordinate system of the auxiliary camera to a coordinate system of the master camera;

Image primary correction step: correcting the original auxiliary visual image based on the constraint of the minimum rotation angle, and based on the initial primary feature point and the target auxiliary feature point which have a matching relationship, so as to obtain a first auxiliary visual image;

Image secondary correction step: correcting the first auxiliary visual image based on the constraint of the minimum parallax, and based on the initial primary feature point and the target auxiliary feature point which have the matching relationship, so as to obtain a target auxiliary visual image.

In order to better understand the above image correction method, the three steps are described separately below.

In the feature point correction step, first, it needs to acquire a pre-construction stereo correction model. The construction process of the stereo correction model includes: determining the coordinate system of the master camera as a reference coordinate system; and constructing the stereo correction model in the reference coordinate system according to a preset calibration parameter of a binocular camera.

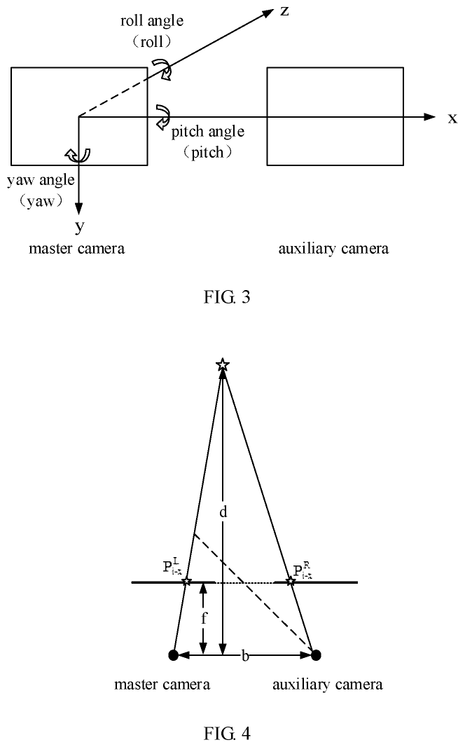

In a specific implementation, referring to the schematic diagram of a binocular model shown in FIG. 3, a parallel binocular model including a master camera and an auxiliary camera is constructed. The coordinate system of the master camera in the parallel binocular model is defined to be consistent with the coordinate system of the master camera in the photographing apparatus. As one alternative implementation, the coordinate system is a spatial three-dimensional space coordinate system established by taking the optical center of the master camera in the parallel binocular model as an origin, taking the direction in which the optical center of the master camera points to the optical center of the auxiliary camera as a second coordinate axis (X axis), taking the optical axis direction of the master camera as a third coordinate axis (Z axis) and taking the direction respectively perpendicular to the second coordinate axis and the third coordinate axis as the first coordinate axis (Y axis). In such case, an angle rotated around the X axis is defined as a pitch angle, an angle rotated around the Y axis is defined as a yaw angle, and an angle rotated around the Z axis is defined as a roll angle. Based on this, the stereo correction model may be acquired as follows:

H_{L}=K_{L}*K_{L}⁻¹ (1)

H_{R}=K_{L}*R⁻¹*K_{R}⁻¹ (2)

wherein H_{L} represents a conversion relationship from the coordinate system of the master camera to the reference coordinate system (that is, the coordinate system of the master camera in the parallel binocular model), K_{L} represents a preset internal parameter matrix of the master camera, H_{R} represents a conversion relationship from the coordinate system of the auxiliary camera to the reference coordinate system, K_{R} represents a preset internal parameter matrix of the auxiliary camera, and R represents a rotation matrix from the coordinate system of the auxiliary camera to the coordinate system of the master camera. The rotation matrix is represented by Euler angle, and Euler angle consists of pitch angle, yaw angle and roll angle. The above calibration parameters K_{L}, K_{R} and R are calibrated and saved before the photographing apparatus leaves the factory.

According to the stereo correction model shown in the above formula (1), it can be seen that the coordinate system of the master camera is consistent with the reference coordinate system, and the initial primary feature point is not corrected. That is, the initial primary feature point remains unchanged. According to the stereo correction model shown in the above formula (2), the initial auxiliary feature point is converted from the coordinate system of the auxiliary camera to the coordinate system of the master camera, so as to obtain the target auxiliary feature point.

Next, when implementing the image primary correction step, the following steps (I) to (III) may be referred to:

(I) Acquiring the coordinate values of the initial primary feature point and the target auxiliary feature point on the second coordinate axis, respectively, based on the coordinate system of the master camera in the photographing apparatus (i.e. the reference coordinate system or the coordinate system of the master camera in the parallel binocular model). Referring to FIG. 3, the first coordinate axis is the y axis. The coordinate value of the i-th initial primary feature point in the master visual image on the Y axis may be expressed as P^{L}_{i-y}, and the coordinate value of the i-th target auxiliary feature point in the auxiliary visual image on the Y axis may be expressed as P^{R}_{i-y}. And referring to the stereo correction model shown in the above formula (2), it may be determined that P^{R}_{i-y}=[(K_{L}*R⁻¹*K_{R}⁻¹)*Pᵢ^{R}]_{y}.

(II) Optimizing a correction cost of a rotation angle according to the acquired coordinate values and LM (Levinberg-Marquardt) algorithm, so as to obtain the minimum rotation angle, wherein the rotation angle is generated in a process of rotating the original auxiliary visual image to align with the master visual image.

In this step, the internal parameter matrix K_{L} of the master camera and the internal parameter matrix K_{R} of the auxiliary camera are constants, the Euler angle R=(Rx,Ry,Rz) is an unknown parameter, and the line alignment is the correction cost of the rotation angle (as shown in formula (3)). The LM algorithm is used to optimize the correction cost of the rotation angle, so as to acquire the minimum rotation angle:

$$\begin{matrix}costFunction ( R ) = costFunction ( Rx , Ry , Rz ) \\ = {\sum }_{i = 1}^{n} \{ {P}_{i - y}^{L} - {[ ( {K}_{L} ⋆ {R}^{- 1} ⋆ {K}_{R}^{- 1} ) ⋆ {P}_{i}^{R} ]}_{y} \} \\ = {\sum }_{i = 1}^{n} \{ {P}_{i - y}^{L} - {P}_{i - y}^{R} \}\end{matrix} \qquad ( 3 )$$

In formula (3), costFunction(R) represents the correction cost of the rotation angle, R represents the rotation angle (or Euler angle) relative to the master visual image during the correction process of the original auxiliary visual image, wherein Rx represents a pitch angle rotated around the X axis, Ry represents a yaw angle rotated around the Y axis, Rz represents a roll angle rotated around the Z axis, and i=1, 2, . . . n.

(III) Correcting the original auxiliary visual image according to the minimum rotation angle, so as to obtain the first auxiliary visual image.

In the image primary correction mode provided by the embodiment of the present disclosure, the coordinate system of the master camera and the master visual image do not move, and the coordinate system of the auxiliary camera and the original auxiliary visual image are rotated to align, which reduces the unknown parameters and increases the robustness.

When the image primary correction is completed, the parallel binocular model can be obtained. The parallel binocular model includes two identical cameras, which are coplanar and collinear. The internal parameter matrices of the two cameras are identical, and the rotation matrix between them is a unit matrix, so the parallel binocular model may be expressed as the following formula (4):

PK_{L}=K_{L}, PR=[RxRyRz],PK_{R}=K_{L} (4)

Formula (4) shows that, in the coordinate system of the parallel binocular model, the internal parameter matrix PK _{L} of the master camera in the parallel binocular model is identical to the internal parameter matrix K_{L} of the master camera in the binocular camera, the rotation matrix PR in the parallel binocular model is identical to the rotation matrix [RxRyRz] in the binocular camera, and the internal parameter matrix PK_{R} of the auxiliary camera in the parallel binocular model is identical to the internal parameter matrix PK_{L} of the master camera in the parallel binocular model, which is also K_{L}.

According to the above-mentioned parallel binocular model and the constraint of the minimum rotation angle, it can be determined that Rx and Rz are accurate, while Ry is uncertain. Based on this, when the image secondary correction step is performed in the embodiment of the present disclosure, Ry may be first constrained by the constraint of the minimum parallax first, which may specifically include the following steps 1) to 5):

1) Acquiring the coordinate values of the initial primary feature point and the target auxiliary feature point on the second coordinate axis, respectively, based on the coordinate system of the master camera. Referring to FIG. 3, the second coordinate axis is the x axis. The coordinate value of the i-th initial primary feature point in the master visual image on the X axis may be expressed as P^{L}ᵢ₋ₓ, and accordingly, the coordinate value of the i-th target auxiliary feature point in the auxiliary visual image on the X axis may be expressed as P^{R}_{i-x.}And referring to the stereo correction model shown in the above formula (2), it may be determined that Pᵢ₋ₓ^{R}=[(K_{L* R}⁻¹*K_{R}⁻¹)*Pᵢ^{R}].

2) Determining a feature point parallax between the initial primary feature point and the target auxiliary feature point which have the matching relationship according to the acquired coordinate values. For example, the feature point parallax may be expressed as xᵢ=Pᵢ₋ₓ^{L}−Pᵢ₋ₓ^{R}.

3) Selecting a plurality of initial matching point pairs with a minimum feature point parallax. The target matching point pairs includes the initial primary feature point and the target auxiliary feature point which have the matching relationship.

According to the following ranging formula (5) and the schematic diagram of a triangulation model shown in FIG. 4, when the feature point parallax xᵢ approaches 0, it means that the feature point is at infinity (the distance greater than 10 meters may be regarded as infinity), and then the Ry value calculated according to that feature point reaches an absolute minimum value.

$$d = \frac{b * f}{{x}_{i}} \qquad ( 5 )$$

wherein b represents a base distance between the master camera and the auxiliary camera, f is a pixel focal length of the master camera, xᵢ is a feature point parallax, and d is a focusing distance of the feature point.

4) Optimizing the correction cost of a yaw angle according to the feature point parallax of the target matching point pair and LM algorithm, so as to obtain a minimum yaw angle. Wherein, the yaw angle is generated in the process of rotating the original auxiliary visual image along the first coordinate axis (i.e. Y axis) to align with the master visual image.

In this step, the internal parameter matrix K_{L} of the master camera, the internal parameter matrix K_{R} of the auxiliary camera, Rx and Rz are constants, and the yaw angle R_{y} is an unknown parameter. The LM algorithm is used to optimize the correction cost of the yaw angle shown in formula (6), so as to acquire the minimum yaw angle:

$$\begin{matrix}costFunction ( Ry ) = {\sum }_{i = 1}^{n} \{ {p}_{i - x}^{L} - {[ ( {K}_{L} ⋆ {R}^{- 1} ⋆ {K}_{R}^{- 1} ) ⋆ {P}_{i}^{R} ]}_{x} \} \\ = {\sum }_{i = 1}^{n} \{ {P}_{i - x}^{L} - {P}_{i - x}^{R} \}\end{matrix} \qquad ( 6 )$$

In the formula (6), costFunction(Ry) represents the correction cost of the yaw angle R_{y}.

In the practical application, it is found that when 3 to 5 pairs of the target matching point pairs with the minimum feature point parallax are selected (that is, n takes 3 to 5), it may have higher robustness.

5) Correcting the first auxiliary visual image according to the minimum yaw angle, so as to obtain the target auxiliary visual image.

In the image secondary correction mode provided by the embodiment of the present disclosure, according to the criterion that the parallax of infinity tends to 0, the unique parallax property of the infinite distance scene is linked with the rotation parameter Ry, and meanwhile, the internal parameter matrix of each camera is unchanged, thereby realizing the double constraints of the image correction process and effectively improving the accuracy of the image correction result.

According to the stereo corrected master visual image and the target auxiliary visual image, the depth image is generated, the region of interest in the depth image is acquired, and the focusing distance of the region of interest is calculated, thereby completing the distance detection.

To sum up, the distance determination method provided by the above embodiment of the present disclosure first improves the alignment accuracy of the rotation angle of the corrected auxiliary visual image with the master visual image under the constraint of the minimum rotation angle; and second, considering that when the feature point parallax approaches 0, which means that the point is at infinity, the matching point pair with the minimum parallax may be used to improve the alignment accuracy of the auxiliary visual image with the master visual image in the vertical direction after re-correction. Based on the above-mentioned correction process, the accuracy of the image correction result can be effectively improved, so that the focusing distance determined thereby can also have high accuracy.

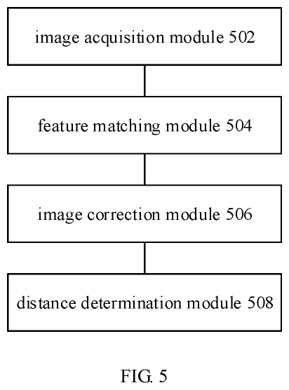

Referring to the distance determination method provided by the above embodiment, the embodiment of the present disclosure provides a distance determination apparatus. Referring to a structural block diagram of a distance determination apparatus shown in FIG. 5, the apparatus includes:

Image acquisition module 502, which is configured to acquire a master visual image photographed by a master camera and an original auxiliary visual image photographed by an auxiliary camera;

Feature matching module 504, which is configured to acquire an initial matching point pair between the master visual image and the original auxiliary visual image through feature extraction and feature matching;

Image correction module 506, which is configured to correct the original auxiliary visual image, sequentially, based on the initial matching point pair and different constraints, so as to obtain a target auxiliary visual image, wherein the different constraints include: a constraint of a minimum rotation angle and a constraint of a minimum parallax; and

Distance determination module 508, which is configured to determine a focusing distance according to the master visual image and the target auxiliary visual image.

In the above distance determination apparatus provided by the embodiment of the present disclosure, first, limited by the constraint of the minimum rotation angle, the accuracy of alignment between the rotation angle of the corrected auxiliary visual image and the master visual image is improved; then, considering that when the feature point parallax approaches 0, which means that the point is at infinity, the matching point pair with the minimum parallax may be used (that is, limited by the constraint of the minimum parallax) to improve the alignment accuracy of the auxiliary visual image with the master visual image in the vertical direction after re-correction. Based on the above-mentioned correction process, the accuracy of the image correction result can be effectively improved, so that the focusing distance determined thereby may also have higher accuracy.

In some embodiments, the feature matching module 504 is further configured to: extract an initial primary feature point in the master visual image and an initial auxiliary feature point in the original auxiliary visual image; calculate a similarity between any feature point pair, wherein the feature point pair includes one initial primary feature point and one initial auxiliary feature point; determine a candidate matching point pair according to the similarity; and screen the candidate matching point according to a sampling consistency algorithm, so as to obtain an initial matching point pair, wherein the initial matching point pair includes the initial primary feature point and the initial auxiliary feature point which have a matching relationship.

In some embodiments, the image correction module 506 is further configured to: correct the initial auxiliary feature point in the initial matching point pair according to a preset stereo correction model, so as to obtain a target auxiliary feature point, wherein the stereo correction model represents a conversion relationship from a coordinate system of the auxiliary camera to a coordinate system of the master camera; correct the original auxiliary visual image based on the constraint of the minimum rotation angle, and based on the initial primary feature point and the target auxiliary feature point which have the matching relationship in the initial matching point pair, so as to obtain a first auxiliary visual image; and correct the first auxiliary visual image based on the constraint of the minimum parallax, and based on the initial primary feature point and the target auxiliary feature point which have the matching relationship, so as to obtain a target auxiliary visual image.

In some embodiments, the image correction module 506 is further configured to: acquire coordinate values of the initial primary feature point and the target auxiliary feature point on a first coordinate axis, respectively, based on the coordinate system of the master camera, wherein the coordinate system of the master camera is a spatial three-dimensional coordinate system established by taking an optical center of the master camera as an origin, taking a direction in which the optical center of the master camera points to the optical center of the auxiliary camera as a second coordinate axis, and taking an optical axis direction of the master camera as a third coordinate axis, wherein the first coordinate axis is a coordinate axis perpendicular to the second coordinate axis and the third coordinate axis; optimize a correction cost of a rotation angle according to the acquired coordinate values and LM algorithm, so as to obtain the minimum rotation angle, wherein the rotation angle is generated in a process of rotating the original auxiliary visual image to align with the master visual image; and correct the original auxiliary visual image according to the minimum rotation angle, so as to obtain the first auxiliary visual image.

In some embodiments, a construction process of the stereo correction model includes: determining the coordinate system of the master camera as a reference coordinate system; and constructing the stereo correction model in the reference coordinate system according to a preset calibration parameter of a binocular camera, wherein the binocular camera includes the master camera and the auxiliary camera.

In some embodiments, the image correction module 506 is further configured to: acquire the coordinate values of the initial primary feature point and the target auxiliary feature point on the second coordinate axis, respectively, based on the coordinate system of the master camera; determine a feature point parallax between the initial primary feature point and the target auxiliary feature point which have the matching relationship according to the acquired coordinate values; select a plurality of initial matching point pairs with a minimum feature point parallax, and taking the selected plurality of the initial matching point pairs as target matching point pairs, wherein the target matching point pair includes the initial primary feature point and the target auxiliary feature point which have the matching relationship; optimize the correction cost of a yaw angle according to the feature point parallax of the target matching point pair and LM algorithm, so as to obtain a minimum yaw angle, wherein the yaw angle is generated in a process of rotating the original auxiliary visual image along the first coordinate axis to align with the master visual image; and correct the first auxiliary visual image according to the minimum yaw angle, so as to obtain the target auxiliary visual image.

The implementation principle and technical effect of the apparatus provided by the embodiment of the present disclosure are the same as those in the foregoing content. For a brief description, for the matters not mentioned in the embodiment of the present disclosure, reference may be made to the corresponding content in the foregoing content.

Based on the above-mentioned description, the present disclosure provides a distance determination system, and the system includes a processor and a storage device; wherein a computer program is stored on the storage device, and when the computer program is executed by the processor, any one of the distance determination methods provided above is implemented.

Those skilled in the art can clearly understand that, for the convenience and brevity of description, the specific working process of the above-described system may refer to the corresponding process in the above-mentioned method embodiments, and will not be repeated here.

In one alternative implementation, the embodiment of the present disclosure also provides a computer-readable storage medium. A computer program is stored on the computer-readable storage medium, and when the computer program is executed by the processor, any one of the distance determination methods provided above is implemented.

A computer program product of the distance determination method, apparatus and system provided by the embodiments of the present disclosure includes a computer-readable storage medium storing program codes. The instructions included in the program codes may be configured to execute the distance determination method described in the above method embodiments. The detailed implementation may be found in the above method embodiments, which will not be repeated here.

The functions, if implemented in the form of software functional units and sold or used as independent products, may be stored in a computer-readable storage medium. Based on such understanding, the technical solution of the present disclosure in essence, or the part that contributes to the prior art or the part of the technical solution may be embodied in a form of a software product. The computer software product is stored in the storage medium and includes several instructions to allow a computer device (which may be a personal computer, a server, or a network device, etc.) to perform all or part of the steps of the methods described in various embodiments of the present disclosure. The above-mentioned storage medium includes: U disk, mobile hard disk, read only memory (ROM), random access memory (RAM), magnetic disk or optical disk and other medium that can store program codes.

It should be noted that, the above-mentioned embodiments are only specific implementations of the present disclosure, which are used to illustrate the technical solutions of the present disclosure, but not to limit them, and the protection scope of the present disclosure is not limited thereto. Although the present disclosure has been described in detail with reference to the above-mentioned embodiments, it should be understood by those skilled in the art that: any person skilled in the art who is familiar with the technical field can still modify the technical solutions described in the above-mentioned embodiments or can easily think of changes, or equivalently replace some technical features thereof within the technical scope disclosed by the present disclosure. These modifications, changes or substitutions do not make the essence of the corresponding technical solutions deviate from the spirit and scope of the technical solutions of the embodiments of the present disclosure, and should all be covered in the protection scope of the present disclosure. Therefore, the protection scope of the present disclosure should be based on the protection scope of the following claims.

### Industrial Applicability

The embodiment of the present disclosure provides a distance determination method, apparatus and system. First, acquiring an initial matching point pair between a master visual image and an original auxiliary visual image; second, correcting the original auxiliary visual image based on the initial matching point pair and based on the constraint of the minimum rotation angle and the constraint of the minimum parallax, so as to obtain the target auxiliary visual image; then, determining a focusing distance of the binocular camera according to the master visual image and the target auxiliary visual image. In the above mode provided by the embodiment of the present disclosure, first, limited by the constraint of the minimum rotation angle, the accuracy of alignment between the rotation angle of the corrected auxiliary visual image and the master visual image is improved; then, considering that when the feature point parallax approaches 0, which means that the point is at infinity, the matching point pair with the minimum parallax may be used (that is, limited by the constraint of the minimum parallax) to improve the alignment accuracy of the auxiliary visual image with the master visual image in the vertical direction after re-correction. Based on the above-mentioned correction process, the accuracy of the image correction result can be effectively improved, so that the focusing distance determined thereby can also have high accuracy.

1. A distance determination method, wherein the method comprises the following steps:
acquiring a master visual image photographed by a master camera and an original auxiliary visual image photographed by an auxiliary camera;
acquiring an initial matching point pair between the master visual image and the original auxiliary visual image through feature extraction and feature matching;
correcting the original auxiliary visual image sequentially, based on the initial matching point pair and different constraints, so as to obtain a target auxiliary visual image, wherein the different constraints comprise: a constraint of a minimum rotation angle and a constraint of a minimum parallax; and
determining a focusing distance according to the master visual image and the target auxiliary visual image.

2. The distance determination method according to claim 1, wherein the step of acquiring the initial matching point pair between the master visual image and the original auxiliary visual image through the feature extraction and the feature matching, comprises:
extracting an initial primary feature point in the master visual image and an initial auxiliary feature point in the original auxiliary visual image;
calculating a similarity between any feature point pair, wherein the feature point pair comprises one initial primary feature point and one initial auxiliary feature point;
determining a candidate matching point pair according to the similarity; and
screening the candidate matching point according to a sampling consistency algorithm, so as to obtain an initial matching point pair, wherein the initial matching point pair comprises the initial primary feature point and the initial auxiliary feature point which have a matching relationship.

3. The distance determination method according to claim 1 or 2, wherein the step of correcting the original auxiliary visual image based on the initial matching point pair and preset constraints, so as to obtain the target auxiliary visual image, comprises:
correcting the initial auxiliary feature point in the initial matching point pair according to a preset stereo correction model, so as to obtain a target auxiliary feature point, wherein the stereo correction model represents a conversion relationship from a coordinate system of the auxiliary camera to a coordinate system of the master camera;
correcting the original auxiliary visual image based on the constraint of the minimum rotation angle, and based on the initial primary feature point and the target auxiliary feature point which have a matching relationship in the initial matching point pair, so as to obtain a first auxiliary visual image; and
correcting the first auxiliary visual image based on the constraint of the minimum parallax, and based on the initial primary feature point and the target auxiliary feature point which have the matching relationship, so as to obtain a target auxiliary visual image.

4. The distance determination method according to claim 3, wherein the step of correcting the original auxiliary visual image based on the constraint of the minimum rotation angle, and based on the initial primary feature point and the target auxiliary feature point which have the matching relationship in the initial matching point pair, so as to obtain the first auxiliary visual image, comprises:
acquiring coordinate values of the initial primary feature point and the target auxiliary feature point on a first coordinate axis, respectively, based on the coordinate system of the master camera, wherein the coordinate system of the master camera is a spatial three-dimensional coordinate system established by taking an optical center of the master camera as an origin, taking a direction in which the optical center of the master camera points to an optical center of the auxiliary camera as a second coordinate axis, and taking an optical axis direction of the master camera as a third coordinate axis, and the first coordinate axis is a coordinate axis perpendicular to the second coordinate axis and the third coordinate axis;
optimizing a correction cost of a rotation angle according to the acquired coordinate values and Levinberg-Marquardt (LM) algorithm, so as to obtain the minimum rotation angle, wherein the rotation angle is generated in a process of rotating the original auxiliary visual image to align with the master visual image; and
correcting the original auxiliary visual image according to the minimum rotation angle, so as to obtain the first auxiliary visual image.

5. The distance determination method according to claim 4, wherein the correction cost of the rotation angle is as follows:
$$\begin{matrix}costFunction ( R ) = costFunction ( Rx , Ry , Rz ) \\ = {\sum }_{i = 1}^{n} \{ {P}_{i - y}^{L} - {[ ( {K}_{L} ⋆ {R}^{- 1} ⋆ {K}_{R}^{- 1} ) ⋆ {P}_{i}^{R} ]}_{y} \} \\ = {\sum }_{i = 1}^{n} \{ {P}_{i - y}^{L} - {P}_{i - y}^{R} \}\end{matrix}$$
wherein costFunction(R) represents the correction cost of the rotation angle, R represents the rotation angle, Rx represents a pitch angle rotated around the second coordinate axis, Ry represents a yaw angle rotated around the first coordinate axis; Rz represents a roll angle rotated around the third coordinate axis, P^{L}_{i- y} represents a coordinate value of the i-th initial primary feature point in the master visual image on the first coordinate axis, and P^{R}_{i-y} represents a coordinate value of the i-th target auxiliary feature point in the auxiliary visual image on the first coordinate axis.

6. The distance determination method according to claim 1, wherein the step of determining the focusing distance according to the master visual image and the target auxiliary visual image, comprises:
calculating a parallax image of the master visual image and the target auxiliary visual image;
converting the parallax image into a depth image according to a conversion relationship between parallax and depth;
determining the focusing distance according to the depth image.

7. The distance determination method according to claim 3, wherein a construction process of the stereo correction model comprises:
determining the coordinate system of the master camera as a reference coordinate system; and
constructing the stereo correction model in the reference coordinate system according to a preset calibration parameter of a binocular camera, wherein the binocular camera comprises the master camera and the auxiliary camera.

8. The distance determination method according to claim 7, wherein the stereo correction model is as follows:
H_{L}=K_{L}*K_{L}⁻¹
H_{R}=K_{L}*R⁻¹*K_{R}⁻¹
wherein H_{L} represents a conversion relationship from the coordinate system of the master camera to the reference coordinate system, K_{L} represents a preset internal parameter matrix of the master camera, H_{R} represents a conversion relationship from the coordinate system of the auxiliary camera to the reference coordinate system, K_{R} represents a preset internal parameter matrix of the auxiliary camera, and R represents a rotation matrix from the coordinate system of the auxiliary camera to the coordinate system of the master camera.

9. The distance determination according to claim 4, wherein the step of correcting the first auxiliary visual image based on the constraint of the minimum parallax, and based on the initial primary feature point and the target auxiliary feature point which have the matching relationship, so as to obtain the target auxiliary visual image, comprises:
acquiring the coordinate values of the initial primary feature point and the target auxiliary feature point on the second coordinate axis, respectively, based on the coordinate system of the master camera;
determining a feature point parallax between the initial primary feature point and the target auxiliary feature point which have the matching relationship according to the acquired coordinate values;
selecting a plurality of initial matching point pairs with a minimum feature point parallax, and taking the selected plurality of the initial matching point pairs as target matching point pairs, wherein the target matching point pair comprises the initial primary feature point and the target auxiliary feature point which have the matching relationship;
optimizing the correction cost of a yaw angle according to the feature point parallax of the target matching point pair and LM algorithm, so as to obtain a minimum yaw angle, wherein the yaw angle is generated in a process of rotating the original auxiliary visual image along the first coordinate axis to align with the master visual image; and
correcting the first auxiliary visual image according to the minimum yaw angle, so as to obtain the target auxiliary visual image.

10. The distance determination according to claim 1, wherein the constraint of the minimum rotation angle comprises:
according to the coordinate values of the feature points in the plurality of the matching point pairs, determining a minimum rotation angle to rotate the original auxiliary visual image to align with the master visual image, wherein the rotation angle is Euler angle.

11. The distance determination according to claim 1, wherein the constraint of the minimum parallax comprises:
determining a minimum yaw angle to rotate the original auxiliary visual image to align with the master visual image by using the coordinate values of the feature points in the plurality of the matching point pairs with the minimum parallax.

12. A distance determination apparatus, wherein the apparatus comprises:
an image acquisition module, configured to acquire a master visual image photographed by a master camera and an original auxiliary visual image photographed by an auxiliary camera;
a feature matching module, configured to acquire an initial matching point pair between the master visual image and the original auxiliary visual image through feature extraction and feature matching;
an image correction module, configured to correct the original auxiliary visual image sequentially, based on the initial matching point pair and different constraints, so as to obtain a target auxiliary visual image, wherein the different constraints comprise: a constraint of a minimum rotation angle and a constraint of a minimum parallax; and
a distance determination module, configured to determine a focusing distance according to the master visual image and the target auxiliary visual image.

13. A distance determination system, wherein the system comprises: a processor and a storage device; wherein a computer program is stored on the storage device, and when the computer program is executed by the processor, the distance determination method according to claim 1 is implemented.

14. A computer-readable storage medium, wherein a computer program is stored on the computer-readable storage medium, and when the computer program is executed by a processor, the distance determination method according to claim 1 is implemented.

15. The distance determination method according to claim 2, wherein the step of correcting the original auxiliary visual image based on the initial matching point pair and preset constraints, so as to obtain the target auxiliary visual image, comprises:
correcting the initial auxiliary feature point in the initial matching point pair according to a preset stereo correction model, so as to obtain a target auxiliary feature point, wherein the stereo correction model represents a conversion relationship from a coordinate system of the auxiliary camera to a coordinate system of the master camera;
correcting the original auxiliary visual image based on the constraint of the minimum rotation angle, and based on the initial primary feature point and the target auxiliary feature point which have a matching relationship in the initial matching point pair, so as to obtain a first auxiliary visual image; and
correcting the first auxiliary visual image based on the constraint of the minimum parallax, and based on the initial primary feature point and the target auxiliary feature point which have the matching relationship, so as to obtain a target auxiliary visual image.

16. The distance determination according to claim 5, wherein the step of correcting the first auxiliary visual image based on the constraint of the minimum parallax, and based on the initial primary feature point and the target auxiliary feature point which have the matching relationship, so as to obtain the target auxiliary visual image, comprises:
acquiring the coordinate values of the initial primary feature point and the target auxiliary feature point on the second coordinate axis, respectively, based on the coordinate system of the master camera;
determining a feature point parallax between the initial primary feature point and the target auxiliary feature point which have the matching relationship according to the acquired coordinate values;
selecting a plurality of initial matching point pairs with a minimum feature point parallax, and taking the selected plurality of the initial matching point pairs as target matching point pairs, wherein the target matching point pair comprises the initial primary feature point and the target auxiliary feature point which have the matching relationship;
optimizing the correction cost of a yaw angle according to the feature point parallax of the target matching point pair and LM algorithm, so as to obtain a minimum yaw angle, wherein the yaw angle is generated in a process of rotating the original auxiliary visual image along the first coordinate axis to align with the master visual image; and
correcting the first auxiliary visual image according to the minimum yaw angle, so as to obtain the target auxiliary visual image.

17. The distance determination apparatus according to claim 12, wherein the feature matching module is further configured to:
extract an initial primary feature point in the master visual image and an initial auxiliary feature point in the original auxiliary visual image;
calculate a similarity between any feature point pair, wherein the feature point pair comprises one initial primary feature point and one initial auxiliary feature point;
determine a candidate matching point pair according to the similarity; and
screen the candidate matching point according to a sampling consistency algorithm, so as to obtain an initial matching point pair, wherein the initial matching point pair comprises the initial primary feature point and the initial auxiliary feature point which have a matching relationship.

18. The distance determination apparatus according to claim 12, wherein the image correction module is further configured to:
correct the initial auxiliary feature point in the initial matching point pair according to a preset stereo correction model, so as to obtain a target auxiliary feature point, wherein the stereo correction model represents a conversion relationship from a coordinate system of the auxiliary camera to a coordinate system of the master camera;
correct the original auxiliary visual image based on the constraint of the minimum rotation angle, and based on the initial primary feature point and the target auxiliary feature point which have a matching relationship in the initial matching point pair, so as to obtain a first auxiliary visual image; and
correct the first auxiliary visual image based on the constraint of the minimum parallax, and based on the initial primary feature point and the target auxiliary feature point which have the matching relationship, so as to obtain a target auxiliary visual image.

19. The distance determination apparatus according to claim 12, wherein the constraint of the minimum rotation angle comprises:
according to the coordinate values of the feature points in the plurality of the matching point pairs, determining a minimum rotation angle to rotate the original auxiliary visual image to align with the master visual image, wherein the rotation angle is Euler angle.

20. The distance determination apparatus according to claim 12, wherein the constraint of the minimum parallax comprises:
determining a minimum yaw angle to rotate the original auxiliary visual image to align with the master visual image by using the coordinate values of the feature points in the plurality of the matching point pairs with the minimum parallax.
